(19) United States
(12) Patent Application Publication
(10) Pub. No.: US 2016/0318054 A1
(43) Pub. Date: Nov. 3, 2016

(54) Device for Detachably Holding a Pump on a Receptacle, in Particular for a Cosmetic Product, and an Assembly Comprising Said Receptacle, Said Pump and a Holding Device of this Type

(71) Applicant: ALBEA LE TREPORT, Le Treport (FR)

(72) Inventors: Pierre Dumont, Dargnies (FR); Frederic Leleu, Le Treport (FR); Herve Lompech, Ansennes Bouttencourt (FR)

(21) Appl. No.: 15/140,687

(22) Filed: Apr. 28, 2016

(30) Foreign Application Priority Data
Apr. 30, 2015 (FR) 1553956

(51) Int. Cl. B05B 11/00; A45D 34/00

(52) U.S. Cl. CPC B05B 11/3047; A45D 34/00; B05B 11/305; B05B 11/3059; A45D 2200/057

(57) ABSTRACT

A device for detachably holding a pump on a receptacle, in particular a bottle intended to contain a cosmetic product. The device has a member for retaining the pump on the receptacle and a holding ring which is firstly capable of being fixed to the receptacle by first fixing means, and secondly capable of holding the retaining member by second fixing means. The second fixing means being designed to allow said retaining member to be fitted on the ring and detached therefrom so as to be able to hold the pump on the receptacle or remove it therefrom.

### CROSS REFERENCE TO RELATED APPLICATIONS

This application claims priority to French Application Serial No. FR1553956, filed Apr. 30, 2015, which is hereby incorporated by reference in its entirety.

### FIELD

The invention relates to a device for detachably holding a pump on a receptacle, in particular to a bottle which is intended to contain a cosmetic product. In particular, it can relate to a receptacle comprising a spray pump which is capable of spraying said cosmetic product.

Generally, such a receptacle comprises a neck, inside which the pump is inserted in part and held and which is associated with a seal. The receptacle comprises means for holding the pump and the seal, formed for example by a ring for crimping the pump on the neck, the ring being equipped with a passage for the pump actuating rod. The actuating rod conducts the cosmetic product from the pump towards a push button which is equipped with a spray nozzle.

### BACKGROUND

Nowadays, a very important aspect for consumers is the ability to refill bottles with cosmetic products once the cosmetic product has been completely used up and the bottle is empty. Consumers want to be able to fill the bottle without having to repurchase the assembly, and thus save on some of the price to pay, knowing that the original bottle has a significant impact on the sale price.

As a consequence, it is necessary to provide bottles which have some parts that are detachable in order to allow the container to be refilled or filled with cosmetic product. For example, in the case of a bottle which is equipped with a pump, it is necessary to be able to remove the pump from the neck in order to fill the container.

There are refillable bottles which are provided with devices for detachably holding the pump. Said devices comprise a resilient crimping ring and a locking cylindrical coupling which surrounds the ring, deforming it at the same time, in order to firmly hold the members together. Thus, in order to detach the pump and refill the product, it is necessary to manipulate the locking cylindrical coupling first, and then the crimping ring thereafter.

Such a device is thus complicated to use due to the number of manipulations, and it also requires an application of considerable force to place or remove the locking cylindrical coupling.

Other devices comprise a ring to be screwed on, bearing a pump. Thus, in order to detach the pump, it is sufficient to simply unscrew the ring. However, such a device requires a screwing movement of the cylindrical coupling on the packaging line, which is time-consuming and costly. In addition, not only is there a risk of poor sealing if the cylindrical coupling is not tightened sufficiently, but there is also a risk of the cylindrical coupling unscrewing itself during transport that generates vibrations, or else due to the expansions of the various parts due to the variations in temperature.

The aim of the invention is thus to obtain a device for detachably holding a pump, which device makes it possible to improve the situation and to simplify the refilling of a receptacle equipped with a pump.

### SUMMARY

For this purpose, the invention relates to a device for detachably holding a pump on a receptacle, in particular a bottle which is intended to contain a cosmetic product, said device comprising a member for retaining the pump on the receptacle and a holding ring which is firstly capable of being fixed to the receptacle by first fixing means, and secondly capable of holding the retaining member by second fixing means, said second fixing means being designed to allow said retaining member to be fitted on said ring and detached therefrom so as to be able to hold the pump on the receptacle or remove it therefrom.

Thus, in order to refill the receptacle with cosmetic product, it is sufficient, owing to the second fixing means, to separate the retaining member from the holding ring, then to remove the pump from the receptacle. The holding ring also remains fixed to the receptacle by the first fixing means.

The manipulation is thus very simple to carry out because the device only requires a single member of the fixing device to be removed in order to reach the pump. Furthermore, since the holding ring remains on the receptacle, it is possible to use second fixing means which are easy to manipulate, and which do not require a particularly great amount of force in order to achieve a firm fastening.

According to different embodiments of the invention, which can be taken together or separately:
said first fixing means are designed to allow permanent attachment to said receptacle,
the first fixing means comprise at least one locking notch which is arranged on the inner face of the holding ring, the locking notch being designed to be blocked by a counter-ring of the receptacle to hold the holding ring on the receptacle,
the first fixing means comprise at least one protuberance which is arranged on the inner face of the holding ring, the protuberance(s) being capable of engaging with an indentation which is arranged in the receptacle in order to prevent the rotation of the holding ring on the receptacle,
the first fixing means comprise two opposing protuberances which are arranged on the inner face of the holding ring, the two protuberances being capable of engaging with two indentations which are arranged on the receptacle,
the holding ring has an annular shape which is capable of surrounding a neck of the receptacle,
the second fixing means comprise a first thread, which is arranged on the retaining member, and a second thread, which is arranged on the holding ring, or, conversely, the first and the second thread being capable of engaging in order to allow the screwing and unscrewing of the retaining member on the holding ring,
the retaining member is equipped with a rim which is capable of abutting the pump in order to hold said pump in position opposite the receptacle when the retaining member is held on the holding ring,
the retaining member is a cylindrical coupling comprising an inner face which is provided with the first thread and the rim,
the retaining member comprises an axial opening which is formed by the rim and designed to allow the passage of an actuating rod of the pump,
the retaining member comprises a recess in which the pump is intended to be fixed in an airtight manner,
the retaining member comprises a surface which is covered for aesthetic purposes,
the body of the push button is less wide than the retaining member, in such a way that it can be inserted into the retaining member at least in part when the pump is actuated.

The invention also relates to an assembly of a holding device of the above-described type and a pump, which is fixed to said device.

Advantageously, said assembly is designed to be joined to said receptacle in an integral manner. In particular, said retaining member and/or said ring are capable of deforming in a resilient manner and/or a clearance is provided between the retaining member and the holding ring in order to allow the holding ring to be attached to a neck of the receptacle without the holding member acting as an obstacle.

The invention also relates to the assembly of a receptacle, in particular for a cosmetic product, a pump and a device of this type for detachably holding the pump. The receptacle advantageously comprises a neck in which the detachable pump is inserted at least in part. Preferably, the receptacle also comprises a seal which is arranged between a baseplate of the retaining member and the neck.

### BRIEF DESCRIPTION OF THE DRAWINGS

The invention will be better understood in light of the following description which is given purely by way of illustration and is not intended to limit the invention, accompanied by the attached drawings:

FIG. 1 is a schematic, exploded, perspective view of a receptacle, a pump and a device for detachably holding said pump, according to one embodiment of the invention,

FIGS. 2a and 2b are schematic cross-sectional front views of said receptacle before and after the assembly, formed by the pump and said holding device, has been joined to said receptacle,

FIG. 3 is a schematic cross-sectional front view of said receptacle, the retaining member and the holding ring of which have been separated in order to remove the pump,

FIG. 4 is a schematic perspective view of the holding ring,

FIG. 5 is a schematic plan view of the holding ring,

FIG. 6 is a schematic cross-sectional view of the holding ring,

FIG. 7 is a schematic perspective view of the holding ring joined to the receptacle,

FIG. 8 is a schematic perspective view of a receptacle according to a second embodiment.

### DETAILED DESCRIPTION

The invention relates to a device 1 for detachably holding a pump for a receptacle, in particular a refillable receptacle.

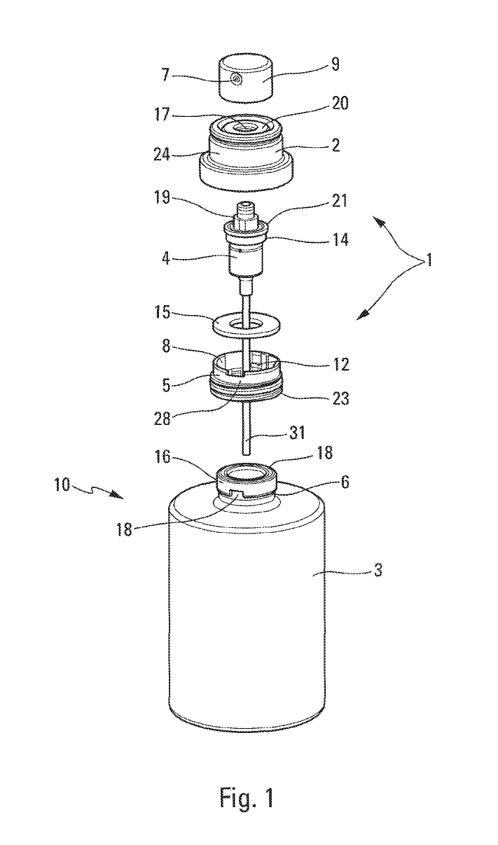

In FIGS. 1 to 3, the receptacle is a bottle 10 which is intended to contain a cosmetic product of the perfume type. The receptacle 10 comprises a container 3 which is preferably made of glass. In this case, it is equipped with a neck 6 and with a pump 4 which is capable of spraying said cosmetic product. It can further comprise a cowl (not shown) for preventing the involuntary actuation of the pump 4.

The pump 4 is connected to the container 3 whilst being held on the neck 6 in such a manner that it can suck up the product contained inside the container 3 whilst acting as a cap for keeping the product inside the container 3. The pump 4 is actuated by means of a button 9 which can be accessed from outside the container 3 when the cowl has been removed. In this case, the push button 9 has a cylindrical body having an opening 7 for distributing the product and an upper bearing wall on which the user exerts a pressure to actuate the pump 4. Thus, the pump 4 sucks the product through a duct 31 which is immersed in the bottom of the bottle, and sprays it through the opening 7 in the button 9. In this case, the opening 7 is a spray nozzle. The neck 6 has a cylindrical shape, as does the pump 4, the majority of which is inserted in and held in the neck 6.

In order to allow the product to be refilled, the pump 4 is held on the neck 6 in a detachable manner. For this purpose, the container 3 is provided with a device 1 for detachably holding the pump 4. Said device 1 comprises a member 2 for retaining the pump 4 on the receptacle and a holding ring 5. The holding ring 5 is firstly capable of being fixed to the receptacle by first fixing means 11, 12 and secondly capable of holding the retaining member 2 by second, reversible fixing means 13, 23. The holding ring 5 thus connects the retaining member 2 to the container 3 in a reversible manner.

The receptacle also comprises a seal 15 which is arranged between a baseplate 38 of the retaining member 2 and the neck 6. The baseplate 38 is provided with an upper raised bead and the top of the neck 6 is provided with a lower raised bead. The upper and lower beads are advantageously offset radially with respect to one another to improve the sealing.

The holding ring 5 has an annular shape which is designed to surround the neck 6 of the receptacle, and the retaining member 2 is a cylindrical coupling which surrounds the holding ring 5 during the joining of the two objects.

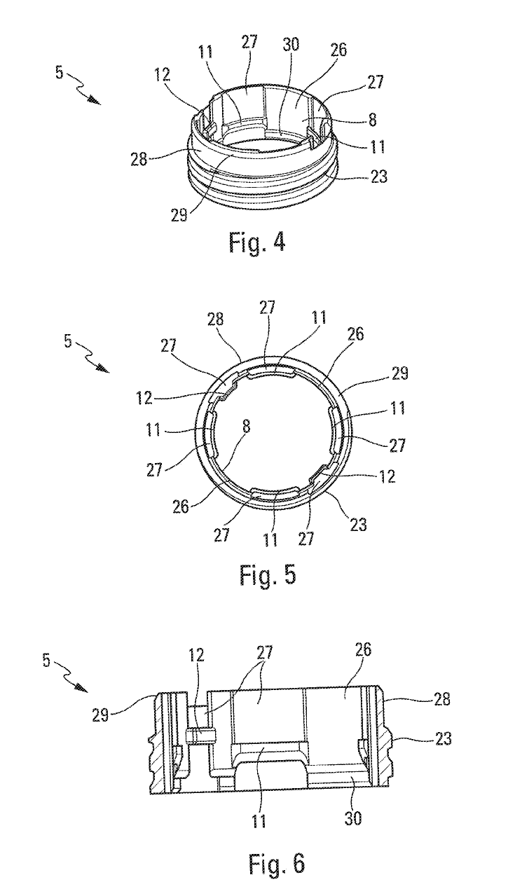

As can be seen more clearly in FIG. 4, the holding ring 5 comprises an inner face 8 which substantially corresponds to the peripheral dimensions of the neck 6 so as to coaxially surround said neck. The holding ring 5 also has an outer face 28 which is intended to be substantially in contact with the retaining member 2, as well as an upper rim 29 which is intended to come into contact with the seal 15 to lock it in the retaining member 2 when the retaining member 2 and the holding ring 5 are joined. The upper rim 29 is also provided with a chamfer in order to facilitate the joining to the retaining member 2. The inner face 8 is also provided with an enlarged portion 30 at the base thereof in order to be able to pre-position the holding ring 5 on the neck 6.

With reference once again to FIGS. 1 to 3, it is noted that the retaining member 2 comprises an inner face 39 having a substantially cylindrical shape so as to be able to surround the holding ring 5. The retaining member 2 is also provided with a rim 20 which is arranged on the inner face 39 of the cylindrical coupling and an axial opening 17 which is formed by the rim 20 inside the cylindrical coupling. The opening 17 is provided as a through-opening in order to allow the passage of an actuating rod 19 of the pump 4 as far as to the button 9, through the device 1 for detachably holding the pump. The rim 20 abuts the pump 4 so as to hold it in position opposite the receptacle. In order words, the rim 20 bears against the pump 4 so as to lock it on the neck 6 when the retaining member 2 is held on the receptacle, the opening 17 being small enough to retain the pump 4. In addition, a falling edge, which extends the rim 20 at the periphery thereof, is intended to bear against the seal 15.

During the actuation of the pump 4, the body of the push button 9 is inserted at least in part into the member 2 for retaining the pump 4. In other words, the body of the push button 9 is less wide than the retaining member 2 so that it can slide inside the inner face 39 of the retaining member 2. Preferably, said body is inserted around the rim 20, along the falling edge.

The retaining member 2 comprises a recess in which the pump 4 is intended to be positioned. The recess is delimited by the rim 20 and the falling edge thereof. In addition, the pump 4 is fixed to said recess in this case. In other words, said pump is locked in a sealing manner inside the recess, in such a way that when the retaining member 2 is removed and separated from the holding ring 5 (see FIG. 3), the pump 4 remains in the recess. Thus, in this embodiment, it is sufficient to remove the retaining member 2 in order to be able to refill the container 3 of the bottle 10, the pump 4 being removed at the same time as the retaining member 2. In this case, the pump 4 is locked in the retaining member 2 by one or more ribs 21 which are arranged on the shoulder 14 of the pump 4 and which engage with a groove 22 made inside in the thickness of the retaining member 2, under the rim 20.

The retaining member 2 can further comprise an outer surface 24 which is covered for aesthetic purposes on the outer face of the cylindrical coupling. Thus, the retaining member 2 is also used as a collar to hide the pump 4 and the neck 6 of the receptacle and to give the bottle 10 a more original appearance by means of the shape and the design of the retaining member 2.

In order to ensure that the ring 5 is held on the container 3, the first fixing means 11, 12 are advantageously permanent. In other words, the holding ring 5 remains connected to the container 3 and is not intended to be removed with the retaining member 2. However, the second fixing means 12, 23 are removable so as to allow the retaining member 2 to be fitted and detached, for example by a rotation operation about a longitudinal axis of said ring 5, which corresponds in this case to a longitudinal axis of the neck 4 of the bottle 10. Thus, when the retaining member 2 is removed from the bottle 10, the retaining member 2 is separated from the holding ring 5 which remains attached to the container 3.

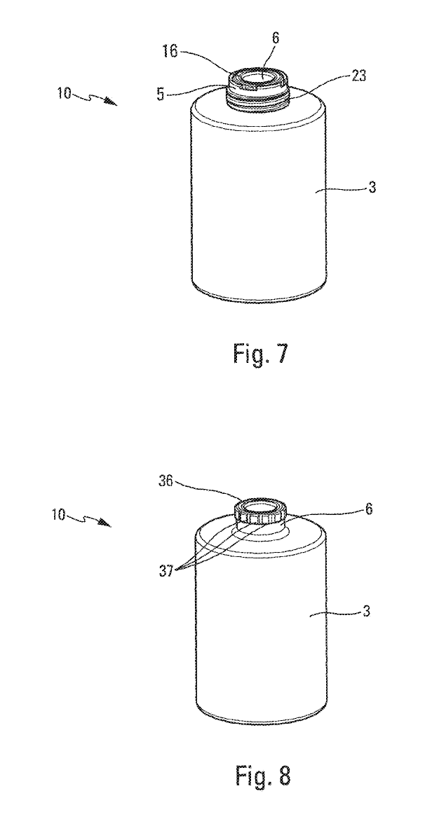

As shown in FIGS. 4 to 6, the first fixing means comprise at least one locking notch 11, in this case four locking notches which are arranged on the inner face 8 of the holding ring 5. When the ring 5 is joined to the neck 6, the locking notches 11 are blocked by a counter-ring 16 which is arranged on the neck 6, as shown in FIG. 1. In this case, the counter-ring 16 is a protuberance in the shape of a coaxial ring around the neck 6 which is made of the same material as the container 3, i.e. glass. The counter-ring 16 is located substantially at the output opening of the neck 6, and the locking notch 11 is located on the inner face 8 of the holding ring 5, in a longitudinal extension direction thereof, in such a way that the holding ring 5 substantially surrounds the neck 6 over the entire height thereof, as shown in FIG. 7.

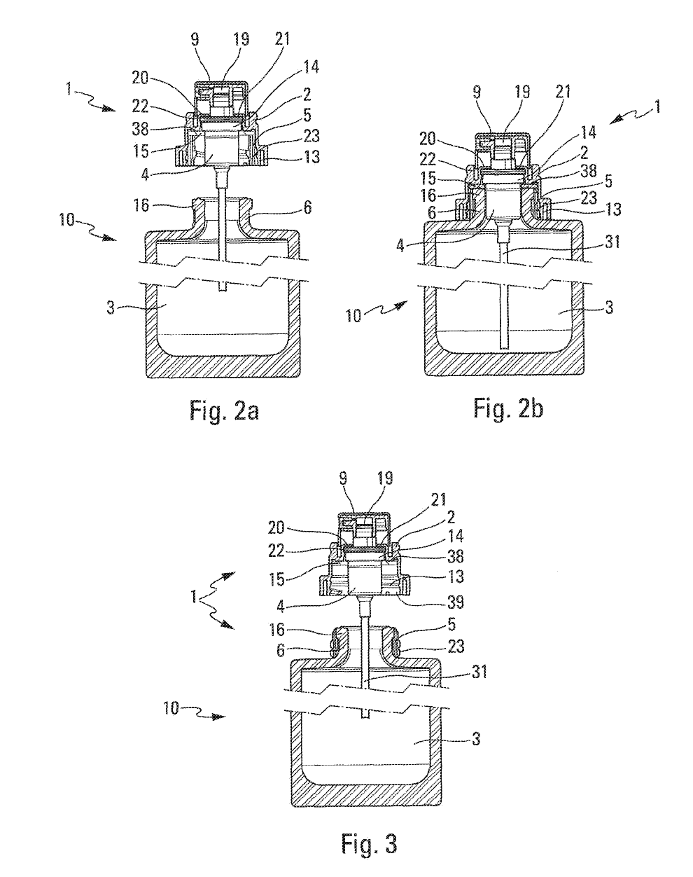

In FIGS. 4 to 6, the locking notch(es) 11 extend at an angle, for example at approximately 90° with respect to the inner face 8. The locking notches 11 in this case are formed by ribs of material which are substantially resilient. Thus, they can deform on the counter-ring 16 of the neck 6 during the positioning of the ring 5 on the container 3, which corresponds to the passage from the configuration shown in FIG. 2a to the configuration shown in FIG. 2b.

In order to prevent the rotation of the holding ring 5 when said ring is fixed to the neck 6, the first fixing means comprise at least one protuberance 12, advantageously two, which are opposing and arranged on the inner face 8 of the holding ring 5, as can be seen in FIGS. 4 to 6. Each protuberance 12 in this case is arranged between two locking notches 11 and is designed to be inserted into an indentation 18 which is arranged in the container 3 from FIG. 1. In this case, the two indentations 18 are substantially horizontal and formed in the counter-ring 16 of the neck 6.

More generally, it is understood that the first fixing means can be designed to prevent the rotation of the ring 5 on the bottle 10 when the retaining member 2 is fixed to or removed from the bottle 10. The protuberances 12 in this case are formed by ribs of material which are substantially horizontal and substantially resilient. Thus, they can deform on the counter-ring 16 of the neck 6 during the positioning of the ring 5 on the container.

FIG. 8 is a variant of a bottle 10 which is equipped with a counter-ring 36 on the neck 6. The counter-ring 36 is equipped with vertical grooves 37 which replace the indentations. In this variant, the protuberances 12 have a shape corresponding to vertical ribs (not shown).

Once again in FIGS. 4 to 6, the inner face 8 of the holding ring 5 also comprises two opposing regions 26 which are intended to be in contact with the counter-ring by increased radial thicknesses; said regions 26 in this case are each arranged at an angle between two locking notches 11. The inner face 8 also comprises hollow portions 27 behind the protuberances 12 and/or the locking notches 12. Thus, said protuberances and/or notches can deform radially during the placement of the holding ring 5 on the neck 6.

According to the invention, said second fixing means 13, 23 are designed to allow said retaining member 2 to be fitted on said ring 5 and detached therefrom so as to be able to hold the pump 4 on the receptacle or remove it therefrom. For this purpose, the second fixing means 13, 23 in this case comprise a first thread 13 which is arranged on the retaining member 2 and a second thread 23 which is arranged on the holding ring 5, as shown in FIGS. 2 and 3. The first thread 13 is arranged on the inner face 39 of the retaining member 2, under the baseplate 38. The second thread 23 is arranged on the outer face 28 of the holding ring 5. The first and the second thread are capable of engaging to allow the retaining member 2 to be screwed onto the holding ring 5 in order to achieve an airtight compression of the seal 15 between the baseplate 38 and the top of the neck 6, and to allow the retaining member 2 to be unscrewed from the holding ring 5. Thus, it is sufficient to unscrew the retaining member 2 from the ring 5 to remove the pump 5 and refill the container 3 with product.

Furthermore, said fixing device, on which the pump will have been fitted beforehand, is preferably designed to be joined to said receptacle in an integral manner, in this case by means of the hollow portions 27 in the ring 5. It is thus possible to join the device 1 to the receptacle, the container 3 of which has preferably been filled in advance, in a reliable manner and with high throughput by simple snapping-in by means of a vertical movement which is applied from top to bottom.

1. Device for detachably holding a pump on a receptacle, said device comprising a member for retaining the pump on the receptacle and a holding ring which is firstly capable of being fixed to the receptacle by first fixing means, and secondly capable of holding the retaining member by second fixing means, said second fixing means being designed to allow said retaining membe to be fitted on said ring and detached therefrom so as to be able to hold the pump on the receptacle or remove it therefrom.

2. Device according to claim 1, wherein said first fixing means are designed to allow permanent attachment to said receptacle.

3. Device according to claim 2, wherein the first fixing means comprise at least one locking notch which is arranged on the inner face of the holding ring, the locking notch being designed to be blocked by a counter-ring of the receptacle to hold the holding ring on the receptacle.

4. Device according to claim 3, wherein the first fixing means comprise at least one protuberance which is arranged on the inner face of the holding ring, the protuberance(s) being capable of engaging with an indentation which is arranged in the receptacle in order to prevent the rotation of the holding ring on the receptacle.

5. Device according to claim 4, wherein the first fixing means comprise two opposing protuberances which are arranged on the inner face of the holding ring, the two protuberances being capable of engaging with two indentations which are arranged on the receptacle.

6. Device according to claim 1, wherein the holding ring has an annular shape which is capable of surrounding a neck of the receptacle.

7. Device according to claim 1, wherein the second fixing means comprise a first thread, which is arranged on the retaining member, and a second thread, which is arranged on the holding ring, the first and the second thread being capable of engaging in order to allow the screwing and unscrewing of the retaining member on the holding ring.

8. Device according to claim 7, wherein the retaining member is equipped with a rim which is capable of abutting the pump in order to hold said pump in position opposite the receptacle when the retaining member is held on the holding ring.

9. Device according to claim 8, wherein the retaining member is a cylindrical coupling comprising an inner face which is provided with the first thread and the rim.

10. Device according to claim 8, wherein the retaining member comprises an axial opening which is formed by the rim and is designed to allow the passage of an actuating rod of the pump.

11. Device according to claim 1, wherein the retaining member comprises a recess in which the pump is intended to be fixed in an airtight manner.

12. Device according to claim 1, wherein the retaining member comprises a surface which is covered for aesthetic purposes.

13. Device according to claim 1, wherein the receptacle is a bottle.

14. Device according to claim 13, wherein the bottle is a cosmetic bottle.

15. Device according to claim 9, wherein the retaining member comprises an axial opening which is formed by the rim and is designed to allow the passage of an actuating rod of the pump.

16. Device according to claim 1, wherein the retaining member is equipped with a rim which is capable of abutting the pump in order to hold said pump in position opposite the receptacle when the retaining member is held on the holding ring.

17. Assembly of a receptacle, a pump and a device for detachably holding the pump according to claim 1.

18. Assembly according to claim 17, wherein said receptacle comprises a neck into which the detachable pump is inserted at least in part.

19. Assembly according to claim 18, comprising a seal which is arranged between a baseplate of the retaining member and the neck.
